(19) United States
(12) Patent Application Publication
(10) Pub. No.: US 2008/0065792 A1
(43) Pub. Date: Mar. 13, 2008

(54) Custom branding of host application based on distributed storage of graphics elements in the attached accessory

(75) Inventors: John Jun Wu, San Diego, CA (US); Thanh Khai Ong, San Diego, CA (US); Kevin Hong Ho, San Diego, CA (US)

Correspondence Address: FOLEY & LARDNER LLP, P.O. BOX 80278, SAN DIEGO, CA, 92138-0278, US

(73) Assignee: Novatel Wireless, Inc.

(21) Appl. No.: 11/518,589

(22) Filed: Sep. 7, 2006

(51) Int. Cl. G06F 13/00

(52) U.S. Cl. 710/16

(57) ABSTRACT

A system and method for custom branding a host application executed on a host device. The host device couples with an accessory device, where a host application is provided for managing/controlling the accessory device. During run time, i.e., when the accessory device is coupled with the host device, the host device can retrieve at least one resource object in which graphical user interface elements associated with the accessory device type have been encoded or preconfigured. The host device can then render the host application with the graphical user interface elements, effectively custom branding the host application.

### FIELD OF THE INVENTION

The present invention relates generally to the field of host application graphical user interfaces. In particular, the present invention relates to providing a graphics resource (skin) on an external device or module, such as a wireless modem card, for use with a host application graphical user interface.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Computer applications generally provide users with some type of graphical user interface (GUI) as the mechanism for interacting with and controlling the computer applications. From the end user perspective, GUIs conventionally consist of graphical elements such as icons, buttons, and menus, that display certain information to the end user, and that the end user can, for example, click to execute an action associated with the computer application. In addition, the display of information associated with a certain computer application is many times presented within a “window” or format specific to that certain computer application.

Traditionally, computer application GUIs have had a set presentation format or layout, always providing end users with a single “look” to the computer application. For example, each of a plurality of end users sees the same color and “branding” programmed into the computer application by the computer application programmer or provider. FIG. 1 shows an exemplary media player application 100 with its standard presentation format and branding. Regardless of what host device, e.g., personal computer (PC), the computer application is running on, that same look will be presented to each end user.

However, a desire to customize the appearance of computer applications has emerged. For some users, the desire to change the look of certain computer applications arises for aesthetic reasons. From a business and marketing standpoint, original equipment manufacturers that produce certain computer applications using a predefined platform want to be able to brand their particular product. Therefore, the concept of using “skins” to change the appearance of computer applications was developed, where a skin can be a set(s) of scripts, image and text files, and/or other media elements. These skin files are used to alter the visual appearance of computer applications by acting as accessories or overlays to the GUI elements of the computer applications.

FIG. 2 shows the same exemplary media player 100 of FIG. 1 skinned to appear as an antique radio. The features and functionality of the exemplary media player 100 of FIG. 1 remain the same, retaining play button 105, stop button 110, fast forward and rewind buttons 115 and 120, and volume control 125, except presented in a different layout. In this example, a first bitmap image file can be used to render the volume control 125 skin shown in FIG. 1, while a second bitmap image file can be used to render the volume control 125 skin shown in FIG. 2. Therefore, the exemplary media player application 100 need only access one skin file or the other at runtime in order to change to its look and presentation.

Generally, skin files are co-located with the computer application. For example, the skin files described above can be stored in a memory unit that resides on the same PC as that which the exemplary media player application 100 is running on. Alternatively, certain prior art allows the skin files to be stored on a remote or external memory unit. However, certain computer applications where customer branding is desired, are not conventionally developed to interact with dedicated memory units. Such computer applications are, for example, wireless modem interface applications, that allow an end user to provision and/or manage a wireless modem card.

Most conventional wireless modem cards are configured to operate on a single system. Therefore, an end user wishing to utilize a General Packet Radio System (GPRS) network for data communications needs to use a wireless modem card configured for GPRS use. If that same end user wishes to communicate using a wireless local area network (W-LAN) utilizing the Institute of Electrical and Electronics Engineers (IEEE) 802.11 standard, he/she needs to use a wireless modem card configured for 802.11 use. Custom branding opportunities arise in this situation for service providers that provide data communications access over these various networks. It would be useful, then, to allow a single wireless modem interface application to be skinned based on the type of wireless modem card utilized on a host device.

### SUMMARY OF THE INVENTION

The present invention comprises a system and method for providing custom branding of a host application, such as a host modem interface application residing on a host device. The host application can manage/control an accessory device, such as a wireless modem card that can be coupled with or embedded in the host device. During run time, i.e., when the accessory device is coupled with the host device, a handshaking procedure takes place which identifies the type of the accessory device. After, or substantially at the same time, the host device can retrieve at least one resource object in which graphical user interface elements associated with the accessory device type have been encoded or preconfigured. The host device can then render the host application with the graphical user interface elements from the resource object, effectively custom branding the host application.

Providing a resource object in an accessory device allows the host application to be less complex because graphic user interface elements do not need to be directly tied to the host application. In addition, a single host application version can be distributed to end users that have different graphics requirements, such as custom logos and text, that need to be associated with the host application, where customization is provided with the accessory device. Because the accessory device must be customized according to the end users, e.g., configured to utilize a certain communication standard, significant cost and/or time requirements are not needed to add the resource object to the accessory device.

These and other features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an exemplary host application that may be skinned according to various embodiments of the present invention;

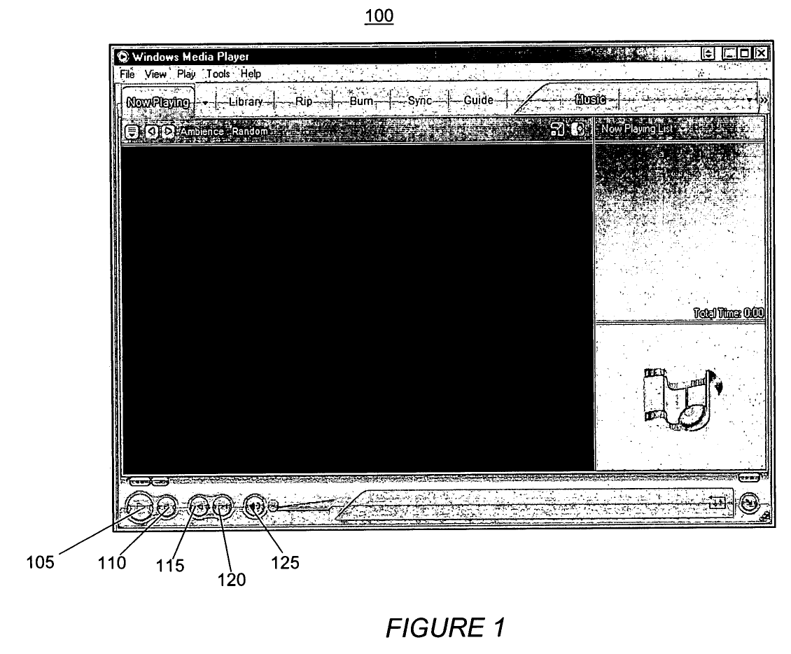

FIG. 2 is the same exemplary host application after being skinned;

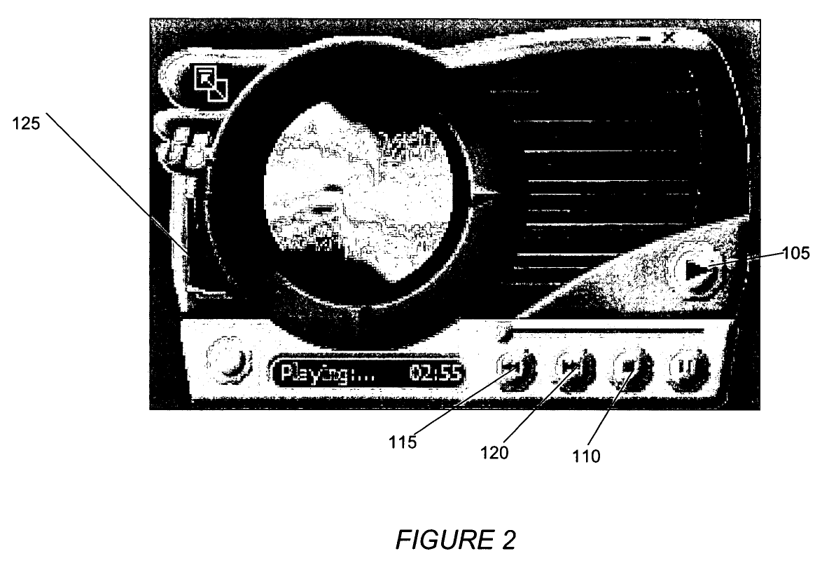

FIG. 3 is a diagram illustrating an exemplary patchwork of wireless communication systems within which various embodiments of the present invention can be utilized;

FIG. 4 is a logical block diagram illustrating one example embodiment of a modem that can be used in the wireless communication systems of FIG. 1 in accordance with various embodiments of the present invention; and

FIG. 5 is a logical diagram illustrating the skin file used in accordance with various embodiments of the present invention.

### DETAILED DESCRIPTION OF THE PREFERRED EMBODIMENTS

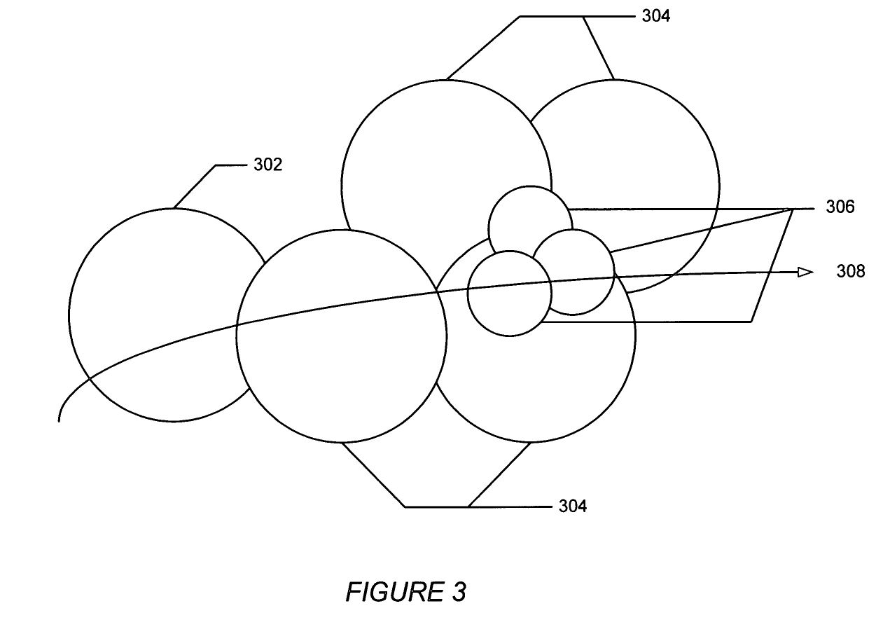

FIG. 3 illustrates a coverage area having various different wireless communication systems. System 302 can, for example, be a WAN type system configured for data communication such as, for example, a (GPRS) Enhanced Data-Rates for GSM Evolution (EDGE), High Speed Circuit Switched Data (HSCSD), Enhanced Circuit Switched Data (ECSD), a 1xRTT data communication system, a Wideband Code Division Multiple Access (WCDMA) system, a Universal Mobile Telecommunication System (UMTS), a High Speed Downlink Packet Access (HSDPA) system, a High Speed Uplink Packet Access (HSUPA), an Evolution Data-Voice (EV-DV) system or an Evolution Data Optimized (EV-DO) system. While systems 304 can, for example, be another type of WAN system, also configured for data or, a WAN system configured for voice communication such as a GSM, IS-136, or IS-95 system. Alternatively, system 304 can, for example, be a Metropolitan Area Network (MAN) such as Worldwide Interoperability for Microwave Access (WiMAX) or Wireless Broadband (WiBro). Systems 306 can be smaller LAN or personal area network (PAN) systems, which will typically be configured for high speed data communication. In general, however, it will be understood that systems 302, 304, and 306 can be any type of WAN, LAN, MAN, or PAN system. Further, as a subscriber moves through systems 302, 304, and 306 along a path such as path 308, for example, the subscriber may have service accounts on some or all of the systems. It should be noted that different communication service providers in a given region each generally provide communication service utilizing different ones of the systems and/or standards discussed above.

If systems 302, 304, and 306 are data communication systems, for example, then the subscriber may be using a laptop or handheld computer, or possibly a personal digital assistant (PDA) device, with an appropriate modem card or module to access each system 302, 304, and/or 306. A common type of modem card used for laptop computers is a Personal Computer Memory Card International Association (PCMCIA) wireless modem card. The subscriber simply purchases the appropriate type of PCMCIA wireless modem card, e.g., GSM, GPRS, EDGE, UMTS, HSDPA, HSUPA, CDMA IxRTT or 1xEV-DO, and then installs it in an available PCMCIA slot in the laptop. As described above, in order to receive service, the subscriber can install the card. If the subscriber moves from system 302 to system 304, the subscriber simply removes the card and installs another card (assuming that the subscriber has an account on both systems).

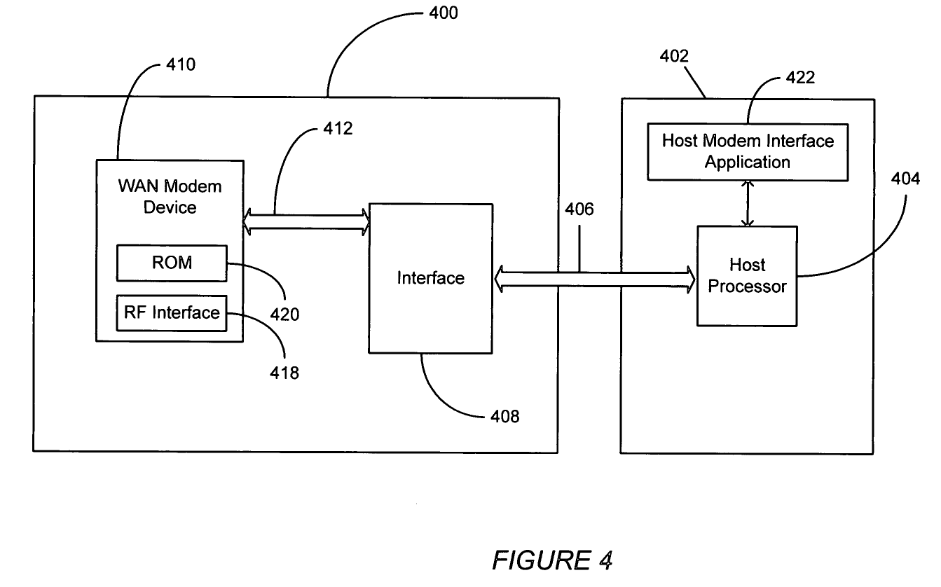

FIG. 4 is a logical block diagram illustrating one example embodiment of a modem 400 configured in accordance with the system and methods described herein. As can be seen, the modem 400 includes a modem device 410. It will be understood that the modem device 410, can be any type of WAN, LAN, MAN, or PAN modem device. Further, the modem device 410 can be configured for data communication, voice communication, or both. For the sake of illustration, however, it will be assumed throughout the examples that follow that the modem device 410 is a WAN modem device configured for data communication, such as a UMTS modem device. It should also be noted that the systems and methods described herein are not restricted to single-mode modems comprising only one modem device. The number of devices can, in fact, be two or more in which case the systems and methods described herein must simply be extended to cover the number of devices included in wireless modem 400.

In addition to the modem device, 410, the modem 400 further comprises an interface device 408 configured to interface the modem device 410 with host processor 404 in host device 402. Thus, for example, the modem 400 can be a PCMCIA modem or Express card and the host device 402 can be a laptop computer with the appropriate PCMCIA card slot. Alternatively, the host device 402 can be a PDA or some other type of portable computing device, in which case the modem 400 is included in the appropriate type of card or module for use with the particular type of host device 402. Further, the wireless modem 400 can be embedded in the host device 402, in which case the interface device 408 may not be needed. For the descriptions that follow, it is assumed that the modem 400 is not within the host device 402 and, therefore, the interface device 408 is present.

As can be seen, the interface device 408 communicates with the modem device 410 over a communication interface 412 and a host processor 404 over a communication interface 406. In one embodiment of the present invention, the modem device 410 also includes a software configurable radio frequency (RF) Interface 418 and read only memory (ROM) 420. The RF Interface 418 can function as a RF head for RF conversion of data during transmission to and from the modem device 410 according to at least one of the standards discussed above, e.g., WAN, LAN, GPRS, etc. The ROM 420 can store fixed variables, tables and other data, including a preconfigured skin. A host modem interface application 422 can manage and/or interact with the modem device 410, as described above, where the host modem interface application 422 comprises a computer program module that is executed by the host processor 404. Executing the host modem interface application 422 prompts at least one display element, such as an application window to be shown on a display screen (not shown) of the host device 402.

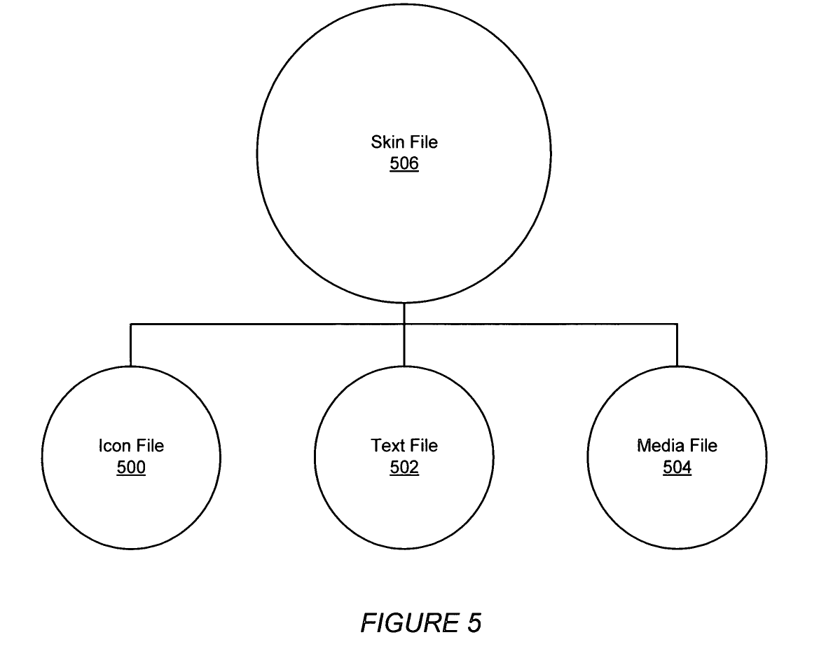

The host device 402 utilizes an operating system, such as Windows XP, that is capable of presenting a GUI to an end user, where various GUI elements such as windows, icons, text, scroll bars, and other visual, audio, and/or animated elements are displayed on the display screen. A computer program application, such as the host modem interface application 422, typically utilizes at least one set of the various GUI elements as graphical/functional building blocks to render a visual and/or functional “look” to the host modem interface application 422. As shown in FIG. 5, the set of the various GUI elements can comprise any number of skin elements, such as icon file 500, text file 502, or other media files, such as media file 504. The set of the various GUI elements themselves, make up a skin file 506. The host modem interface application 422 in turn, is comprised of at least one executable file, which has programmed therein, at least one pointer or drawing procedure for directing the host modem application 422 to an appropriate skin file, such as the skin file 506.

Because the properties of the GUI element, for example, the color and shape of an icon defined in the icon file 500, are not directly programmed into the host modem interface application 422, the host modem application 422 only needs a graphical template programmed therein. Depending on which skin file the host modem interface application 422 is pointed to, the graphical template will be populated with the properties of the icon file 500, text file 502, etc., resulting in a skinned application for presentation to an end user. From a programming standpoint, the graphics elements of the host modem interface application 422 can also be separated out in a resource object, where the resource object represents a skin file, such as the skin file 506. At run time, the resource object is loaded by the host modem interface application 422 and used to render a skinned application for presentation to the end user.

At run time, i.e., when the wireless modem 400 is inserted into the PCMCIA slot of the host device 402 and/or powered on, the host modem interface application and the wireless modem 400 engage in a handshaking procedure via the host processor 404. This allows the host modem interface application 422 and the host processor 404 to determine the type of the modem device 410. During this handshaking procedure, the RF Interface 418 can send an identification signal to the host processor 404 identifying itself as one of the wireless modem types discussed above. It should be noted that the identification signal can be sent over the communication interface 412 or over the air using one of the plurality of wireless communication standards discussed above. Once the modem device 410 type is known, the host processor 404 accesses ROM 425 to retrieve the skin file. Alternatively, the skin file 506 can be retrieved by the host processor 404 during the handshaking procedure. Therefore, the at least one display element will appear on the display screen with the customer logo, text, or other media elements associated with the service provider that provides access of the type that the modem device 410 has been determined to use. It should be noted that the skin file 506 and the skin elements, 500, 502, and 504 can be defined using any appropriate programming language or format, such as, but not limited to extensible markup language (XML), Java, and bitmap formats.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the word “device,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of skinning a host application comprising:
communicatively coupling an accessory device to a host device, wherein the host device executes the host application for managing the accessory device;
determining a type of the accessory device;
retrieving at least one resource object from the accessory device; and
rendering a graphical user interface of the host application based upon the at least one retrieved resource object.

2. The method of claim 1, wherein the accessory device comprises a wireless modem card.

3. The method of claim 1, wherein the determining of the type of the accessory device further comprises engaging in a handshaking procedure.

4. The method of claim 3, wherein the handshaking procedure further comprises receiving an identification signal from a radio frequency identifier of the accessory device identifying the accessory device as operating using one of a plurality of communications standards.

5. The method of claim 1, wherein the retrieving of the resource object is performed utilizing standard computer electrical interfaces.

6. The method of claim 1, wherein the retrieving of the resource object is performed utilizing an over-the-air wireless interface.

7. The method of claim 1, wherein the at least one resource object comprises a skin file.

8. The method of claim 7, wherein the skin file comprises at least one graphical user interface media element,

9. The method of claim 8, wherein the graphical user interface media element is one of a visual element, a text element, an audio element, and an animated element.

10. A computer program product, embodied on a computer-readable medium, for skinning a host application comprising:
computer code for communicatively coupling an accessory device to a host device, wherein the host device executes the host application for managing the accessory device;
computer code for determining a type of the accessory device;
computer code for retrieving at least one resource object from the accessory device; and
computer code for rendering a graphical user interface of the host application based upon the at least one retrieved resource object.

11. The computer program product of claim 10, wherein the accessory device comprises a wireless modem card.

12. The computer program product of claim 10, further comprising receiving an identification signal from a radio frequency identifier of the accessory device identifying the accessory device as operating using one of a plurality of communications standards.

13. The computer program product of claim 10, wherein the retrieving of the resource object is performed utilizing standard computer electrical interfaces.

14. The computer program product of claim 10, wherein the retrieving of the resource object is performed utilizing an over-the-air wireless interface.

15. The computer program product of claim 10, wherein the at least one resource object comprises a skin file.

16. An accessory device comprising:
an interface; and
a memory unit communicatively connected to the interface; and including:
computer code for communicatively coupling the accessory device to a host device, wherein the host device executes a host application for managing the accessory device;
computer code for determining a type of the accessory device;
computer code for forwarding at least one resource object from the accessory device; and
computer code for rendering a graphical user interface of the host application based upon the at least one retrieved resource object.

17. The accessory device of claim 19, further comprising computer code for forwarding an identification signal from a radio frequency identifier of the accessory device identifying the accessory device as operating using one of a plurality of communications standards.

18. A system comprising:
a host device for executing a host application;
an accessory device for communicative coupling to the host device, wherein the host application provides a management interface for the accessory device;
the accessory device including memory for storing the at least one resource object, wherein at least one resource object is retrieved by the host device upon determining a type of the accessory device, and the management interface of the host application is graphically rendered based upon the at least one retrieved resource object.
